(19) United States
(12) Patent Application Publication
(10) Pub. No.: US 2026/0200383 A1
(43) Pub. Date: Jul. 16, 2026

(54) VEHICLE SEAT DEVICE FOR ASSISTANCE DURING ENTRANCE AND EXIT OF A VEHICLE

(71) Applicant: University of Pittsburgh-Of the Commonwealth System of Higher Education, Pittsburgh, PA (US)

(72) Inventor: Julie Faieta, Pittsburgh, PA (US)

(21) Appl. No.: 19/136,364

(22) PCT Filed: Dec. 7, 2023
(86) PCT No.: PCT/US2023/082929

§ 371 Date: Jun. 6, 2025

Related U.S. Application Data
(60) Provisional application No. 63/431,155, filed on Dec. 8, 2022.

(51) Int. Cl. B60N 2/90; A61G 5/14; B60N 2/14

(52) U.S. Cl. CPC B60N 2/90; A61G 5/14; B60N 2/14

(57) ABSTRACT

A vehicle seat device includes a base and a seat connected to the base. The seat includes a dynamic section that is rotatable relative to the base. At least a portion of the dynamic section is tiltable relative to the base from an untilted to a tilted position. In the untilted position, the surface of the dynamic section may, for example, be approximately parallel to a seat of a vehicle.

### CROSS-REFERENCE TO RELATED APPLICATIONS

This application claims benefit of U.S. Provisional Patent Application Ser. No. 63/431,155, filed Dec. 8, 2022, the disclosure of which is incorporated herein by reference.

### BACKGROUND

The following information is provided to assist the reader in understanding technologies disclosed below and the environment in which such technologies may typically be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

Numerous people face challenges in vehicle transfers (entering and exiting) as a result of, for example, impaired or decreased mobility, balance, and strength. Such challenges may also be caused or exacerbated by cognitive impairment. Vehicle transfers for individuals with decreased functional mobility, whether as a result of age, injury, disease, or other disability, are difficult and time consuming. In addition, caregivers working to assist impaired individuals with transferring into and out of vehicles can find themselves in biomechanically compromised postures that increase risk of injury (for example, when bending and twisting to assist their loved one in putting their feet into the vehicle). The U.S. Department of Transportation, National Highway Safety Administration reports that 23%, or 147,000 of 647,000, of all non-crash vehicle incidents are accounted for by injuries obtained when transitioning into or out of vehicles.

Professional caregivers such as occupational therapist may provide education on safe vehicle transfer techniques. A person who has challenges in completing vehicle transfer may, for example, be taught techniques of vehicle transfer in which, at all times during the transfer, either: (i) the person's feet are in contact with the ground or (ii) the person is seated. For example, an impaired person is typically trained to face away from the vehicle with the door in an open state and then lean/sit back into the vehicle seat. Once seated, the person lifts their feet off the ground and rotates their torso and legs approximately 90° so that the user is facing forward in the seat. The process is reversed when exiting the vehicle. In that regard, the torso and legs are rotated approximately 90° so that the user is facing away from the vehicle. The person then tilts forward so that gravity assists in the person's feet making contact with the ground as the person becomes unseated and stands. While such techniques may increase safety, they are often not easy for impaired individuals to carry out.

A number of devices and systems have been developed to facilitate vehicle transfer. Some involve vehicle modification such as replacement of the vehicle seat with a powered mechanical assist device. Such options are quite expensive. Lower tech, less expensive options typically do not provide adequate safety or adequately facilitate the motions required of a user to achieve safe transfer.

It remains desirable to develop new technologies for assisting individuals to achieve vehicle transfer (that is, achieve entering and exiting) a vehicle in a safe manner.

### SUMMARY

In one aspect, a vehicle seat device includes a base and a seat (or device seat) connected to the base. The seat includes a dynamic section that is rotatable relative to the base. At least a portion of the dynamic section is tiltable relative to the base from an untilted to a tilted position. In the untilted position, the surface of the dynamic section may, for example, be approximately parallel to a vehicle seat of a vehicle. The vehicle seat device may, for example be incorporated into a seat of a vehicle (or vehicle seat). In a number of embodiments, the base is configured to be positioned on top of a seat of a vehicle.

In a number of embodiments, the seat of the vehicle seat device comprises a static section and the dynamic section, wherein the static section is not movable relative to the base. The base may, for example, include a base plate and a frame extending upward from the base plate. In a number of embodiments, the frame includes an arced section in which at least a portion of the dynamic section of the seat is rotatably positioned.

The dynamic section may include a lower or base section and an upper plate operative connected to the lower or base section, wherein the upper plate section is tiltable relative to the base section. At least one tilt actuator may be positioned between the base section and the upper plate of the dynamic section. In a number of embodiments, the at least one tilt actuator comprises an inflatable bladder. In a number of embodiments, the device further include a ball bearing track positioned between the base of the vehicle seat device and the base section of the dynamic section.

The upper plate may, for example, be tiltably connected to the base section of the dynamic section via a hinge. The arced section of the frame may include an opening and the hinge abuts edges of the opening to limit rotation of the dynamic section relative to the base. In a number of embodiments, rotation of the dynamic section relative to the base is limited to approximately 90 degrees.

The base may, for example, further include an interface attached to a lower surface of the base, the interface being configured to conform to a conformation of the vehicle seat. At least a portion of the dynamic section may be configured to provide a forward tilt in the tilted position to assist in at least one of exiting or entering the vehicle.

In another aspect, a method of providing assistance in transfer of a user in entering and exiting a vehicle includes positioning a vehicle seat device in operative connection with a seat of the vehicle. The vehicle seat device includes a base and a seat connected to the base. The seat includes a dynamic section that is rotatable relative to the base. At least a portion of the dynamic section is tiltable relative to the base. The dynamic section is rotatable relative to the base upon force applied by a user when seated on the vehicle seat device. The method further includes tilting the at least a portion of the dynamic section from an untilted position to a tilted position to provide a forward tilt to the user to assist in at least one of exiting or entering the vehicle.

In a number of embodiments, the vehicle seat device is incorporated into a seat of a vehicle. In a number of other embodiments, the base is configured to be positioned on top of a vehicle seat and the method includes positioning the vehicle seat device on top of the vehicle seat.

The seat may include a static section and the dynamic section, wherein the static section is not movable relative to the base. In a number of embodiments, the base includes a base plate and a frame extending upward from the base plate, and the frame includes an arced section in which at least a portion of the dynamic section of the seat is rotatably positioned. The dynamic section may include a base section and an upper plate operative connected to the base section, wherein the upper plate section is tiltable relative to the base section.

The vehicle seat device may include at least one tilt actuator positioned between the base section and the upper plate of the dynamic section. In a number of embodiments, the at least one tilt actuator comprises an inflatable bladder.

The provided vehicle seat device may further include a ball bearing track positioned between the base of the vehicle seat device and the base section of the dynamic section. In a number of embodiments, the upper plate is tiltably connected to the base section of the dynamic section via a hinge. The arced section of the frame may include an opening and the hinge abuts edges of the opening to limit rotation of the dynamic section relative to the base. Rotation of the dynamic section relative to the base may, for example, be limited to approximately 90 degrees.

In a number of embodiments, the base further includes an interface attached to a lower surface of the base, wherein the interface is configured to conform to a conformation of the vehicle seat.

In a number of embodiments, the method further includes rotating the dynamic section to a determined position wherein tilting the at least a portion of the dynamic section provides a forward tilt to the user in the tilted position to assist exiting of the user from the vehicle during an exit process.

In a further aspect, a method of facilitating at least one of entry or exit from a vehicle includes providing a vehicle seat device in operative connection with a set of the vehicle, wherein the vehicle seat device includes a base and a seat connected to the base. The seat includes a dynamic section that is rotatable relative to the base. At least a portion of the dynamic section is tiltable from an untilted position to a tilted position relative to the base.

The present devices, systems, and methods along with the attributes and attendant advantages thereof, will best be appreciated and understood in view of the following detailed description taken in conjunction with the accompanying drawings.

### BRIEF DESCRIPTION OF THE DRAWINGS

FIG. 1A illustrates a side view of a representative embodiment of a vehicle seat device hereof for assistance in vehicle transfer.

FIG. 1B illustrates a perspective exploded view of the vehicle seat device of FIG. 1A.

FIG. 1C illustrates a side cutaway view of a portion of the vehicle seat device of FIG. 1A.

FIG. 2A illustrates an isometric view of another representative embodiment of a vehicle seat device hereof.

FIG. 2B illustrates an isometric view showing tilting of a portion of a rotatable, dynamic section of the seat of the vehicle seat device of FIG. 2A.

FIG. 2C illustrates an isometric view of a base of the vehicle seat device of FIG. 2A including a portion of the dynamic section of the seat rotatably seated within the base.

FIG. 3 illustrates a perspective view of the vehicle seat device of FIG. 2A positioned on a vehicle seat.

FIG. 4 illustrates another isometric view of the vehicle seat device of FIG. 2A.

FIG. 5 illustrates an isometric exploded view of the vehicle seat device of FIG. 2A.

FIG. 6 illustrates another isometric exploded view of the vehicle seat device of FIG. 2A.

FIG. 7A illustrates another isometric view of the base of the vehicle seat device of FIG. 2A showing a circular ball bearing track in operative connection with the base.

FIG. 7B illustrates another isometric view of the base of the vehicle seat device of FIG. 2A showing a lower portion of the dynamic section of the seat including actuators in the form inflatable bladders, which are inflatable to achieve tilting of an upper portion of the dynamic section, positioned in connection with the lower portion of the dynamic section.

FIG. 8 illustrates an isometric exploded view of the dynamic section of the seat vehicle device of FIG. 2A which rotates with the user.

FIG. 9 illustrates an isometric exploded view of several components of the base of the seat vehicle device of FIG. 2A.

### DETAILED DESCRIPTION

It will be readily understood that the components of the embodiments, as generally described and illustrated in the figures herein, may be arranged and designed in a wide variety of different configurations in addition to the described representative embodiments. Thus, the following more detailed description of the representative embodiments, as illustrated in the figures, is not intended to limit the scope of the embodiments, as claimed, but is merely illustrative of representative embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein and in the appended claims, the singular forms “a,” “an”, and “the” include plural references unless the context clearly dictates otherwise. Thus, for example, reference to “an actuator” includes a plurality of such actuators and equivalents thereof known to those skilled in the art, and so forth, and reference to “the actuator” is a reference to one or more such actuators and equivalents thereof known to those skilled in the art, and so forth. Recitation of ranges of values herein are merely intended to serve as a shorthand method of referring individually to each separate value falling within the range. Unless otherwise indicated herein, each separate value, as well as intermediate ranges, are incorporated into the specification as if individually recited herein. All methods described herein can be performed in any suitable order unless otherwise indicated herein or otherwise clearly contraindicated by the text.

The terms “electronic circuitry”, “circuitry” or “circuit,” as used herein include, but is not limited to, hardware, firmware, software, or combinations of each to perform a function(s) or an action(s). For example, based on a desired feature or need, a circuit may include a software-controlled microprocessor, discrete logic such as an application specific integrated circuit (ASIC), or other programmed logic device. A circuit may also be fully embodied as software. As used herein, “circuit” is considered synonymous with “logic.” The term “logic”, as used herein includes, but is not limited to, hardware, firmware, software, or combinations of each to perform a function(s) or an action(s), or to cause a function or action from another component. For example, based on a desired application or need, logic may include a software-controlled microprocessor, discrete logic such as an application specific integrated circuit (ASIC), or other programmed logic device. Logic may also be fully embodied as software.

The term “processor,” as used herein includes, but is not limited to, one or more of virtually any number of processor systems or stand-alone processors, such as microprocessors, microcontrollers, central processing units (CPUs), and digital signal processors (DSPs), in any combination. The processor may be associated with various other circuits that support operation of the processor, such as random-access memory (RAM), read-only memory (ROM), programmable read-only memory (PROM), erasable programmable read only memory (EPROM), clocks, decoders, memory controllers, or interrupt controllers, etc. These support circuits may be internal or external to the processor or its associated electronic packaging. The support circuits are in operative communication with the processor. The support circuits are not necessarily shown separate from the processor in block diagrams or other drawings.

The term “controller,” as used herein includes, but is not limited to, any circuit or device that coordinates and controls the operation of one or more input and/or output devices. A controller may, for example, include a device having one or more processors, microprocessors, or central processing units capable of being programmed to perform functions.

The term “software,” as used herein includes, but is not limited to, one or more computer readable or executable instructions that cause a computer or other electronic device to perform functions, actions, or behave in a desired manner. The instructions may be embodied in various forms such as routines, algorithms, modules, or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, or the desires of a designer/programmer or the like.

As used herein, the term “personal communications device” refers to a portable or mobile device which includes a communication system, a processor system, a user interface system (for example, a visual feedback system including a touchscreen or other display, an auditory feedback system, and a tactile feedback system, a user input system etc.) and an operating system capable of running general-purpose applications. Examples of personal communications devices include, but are not limited to, smartphones, tablet computer and custom devices. As used herein, the term “tablet computer” or tablet, refers to a mobile computer with a communication system, a processor system, at least one user interface as described above (typically including a touchscreen display), and an operating system capable of running general-purpose applications in a single unit. As used herein, the term “smartphone” refers to a cellular telephone including a processor system, at least one user interface as described above (typically including a touchscreen display), and an operating system capable of running general-purpose applications. Such personal communication devices are typically powered by rechargeable batteries and are housed as a single, mobile unit. Moreover, in a number of embodiments personal communications devices are able accept input directly into a touchscreen (as opposed to requiring a keyboard and/or a mouse). Personal communications devices as typically provide for internet access through cellular networks and/or wireless internet access points connected to routers.

As used herein, the term “approximately” or “approximate” when used in connection with a certain value generally means within 10%, beneficially within 5%, or more beneficially within 2% unless otherwise indicated herein or otherwise clearly contraindicated by the text.

In a number of embodiments, a vehicle seat device hereof facilitates execution of transfer (or entry and/or exit) techniques into and out of a vehicle in an improved (for example, safer and easier) manner through at least one of turn and tilt functions. In general, a portion of the vehicle seat device hereof which is contacted by a user may rotate or turn over a range of angles to facilitate turning of the user's torso and legs during vehicle transfer. Further, a tilt feature facilitates unseating of the user and the use of gravity in contacting the user's feet with the ground during exiting the vehicle and/or facilitates a lean of the user toward a “forward fall” motion that brings the user's center of gravity forward in preparation to stand. The devices, systems, and methods hereof are discussed in connection with a number of embodiments wherein a vehicle seat device hereof may be placed on top of an existing vehicle seat. Such embodiments provide a number of advantages including portability, ease of use with virtually any seat of a broad variety of vehicles, relatively low expense, etc. As clear to those skilled in the art, however, the vehicle seat device hereof may readily be incorporated into or integrated with a vehicle seat.

In a number of embodiments, a dynamic or moveable section of vehicle seat devices hereof may be readily rotated approximately 90° relative to a stationary base of the device. In a number of embodiments, the vehicle seat devices hereof function as an overlay on a vehicle seat. In that regard, a base section of the vehicle seat device may rest upon the vehicle seat. The seating section seat, which includes the dynamic section and may include cushioning for comfort, is positioned above or on top of the base. The dynamic section of the vehicle seat device allows the user to sit back into the vehicle when entering, then to easily turn or twist to a forward facing position with minimal effort from the user and very little if any shearing forces upon the user. Such a turn, from a position in which the user is facing toward an outside of the vehicle to a frontward facing position, while aligning with safe transfer techniques, can be very challenging and time consuming for individuals who suffer from decreased mobility, balance, strength, and/or cognition as a result of age or disease. Additionally, the vehicle seat devices hereof provide a tilt function wherein the seat or the dynamic section of the seat, tilts relative to the base to provide an anterior tilt of the seat when the user is facing away from the vehicle. Such an anterior tilt may provide support in the sit to stand motion/transition when exiting the vehicle and the stand to sit motion/transition in entering the vehicle.

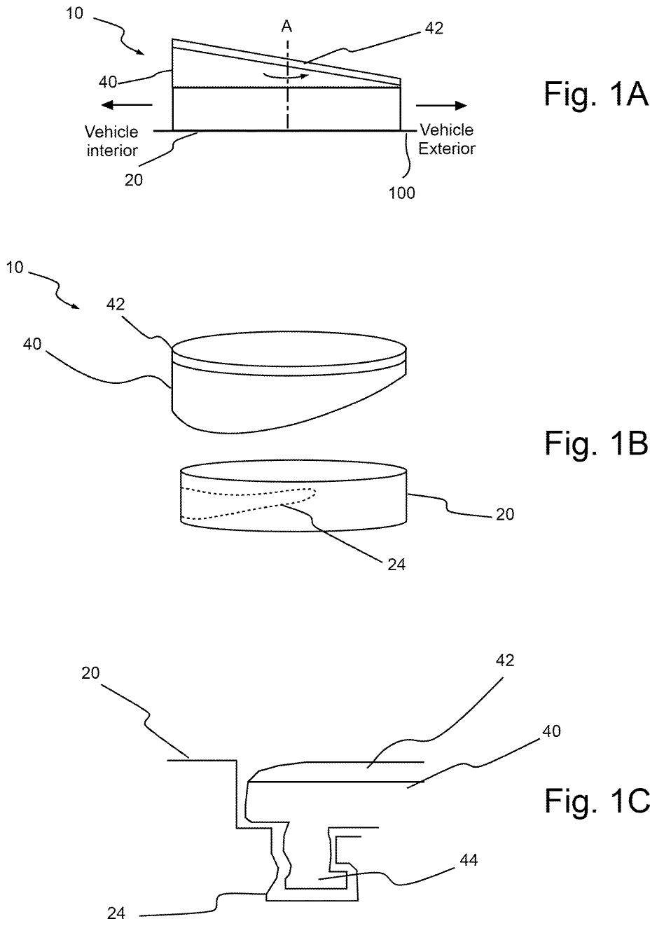

FIGS. 1A through 1C illustrate a representative embodiment of a device 10 hereof including a base 20, which is designed to sit on top of a vehicle seat 100 (see FIG. 1A), in operative connection with a seating section or seat 40. In a number of embodiments, connectors such as straps may be used to secure device 10 to vehicle seat 100. Seat 40 includes a cushion 42 on an upper surface thereof for user comfort. Seat 40 (or a portion thereof) is rotatable about an axis A relative to base 20 over approximately 90° as described above to facilitate vehicle transfer of a user. As illustrated in FIGS. 1B and 1C, base 20 includes a sloped or ramped slot or track 24 (see, for example, FIG. 1B) in the illustrated embodiment which cooperates with a cooperating element 44 (see FIG. 1C) so that, when seat 40 rotates with the user upon performing a safe exiting maneuver during which the user rotates to face a direction exterior to the car, an anterior (relative to the user) tilt of seat 40 is created relative to the plane of base 20 (see FIG. 1A). Such an anterior tilt of the seat 40 (which may, for example, be in the approximate ranges of 5° to 50°, 10° to 40°, or 15° to 30° relative to the plane of base 20) provides support in, for example, the sit to stand motion of the user required when exiting the vehicle. In the embodiment of FIGS. 1A through 1C, the anterior tilt of seat 40 levels out (that is, the seat returns to a plane of orientation approximately parallel to the planes of base 20 and vehicle seat 100) during the turn to face front to ensure the seated user is positioned naturally while riding in the vehicle. As set forth above, the anterior tilt of seat 40 also facilitates the sitting motion when entering the vehicle.

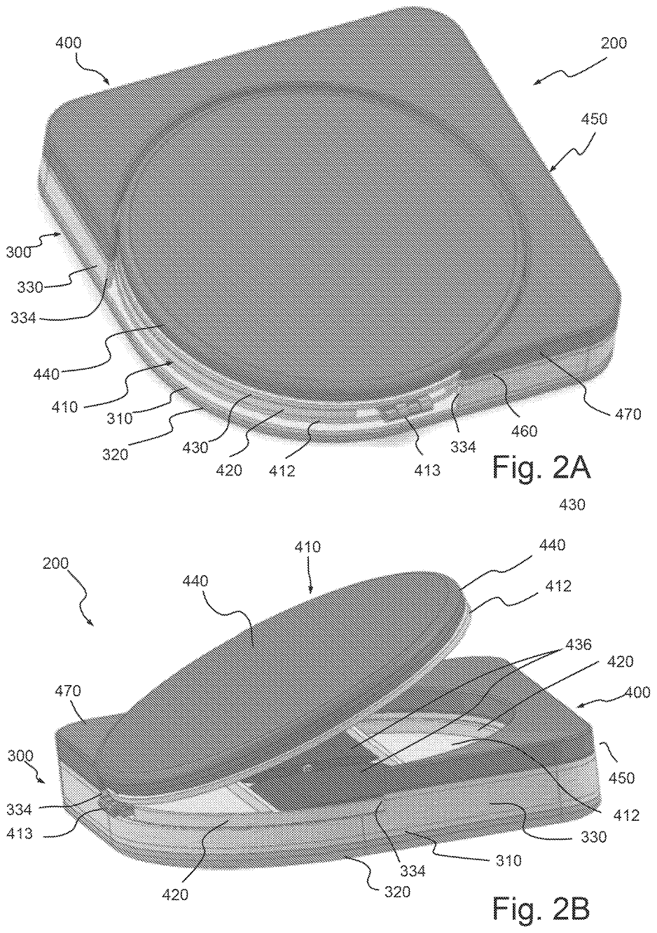

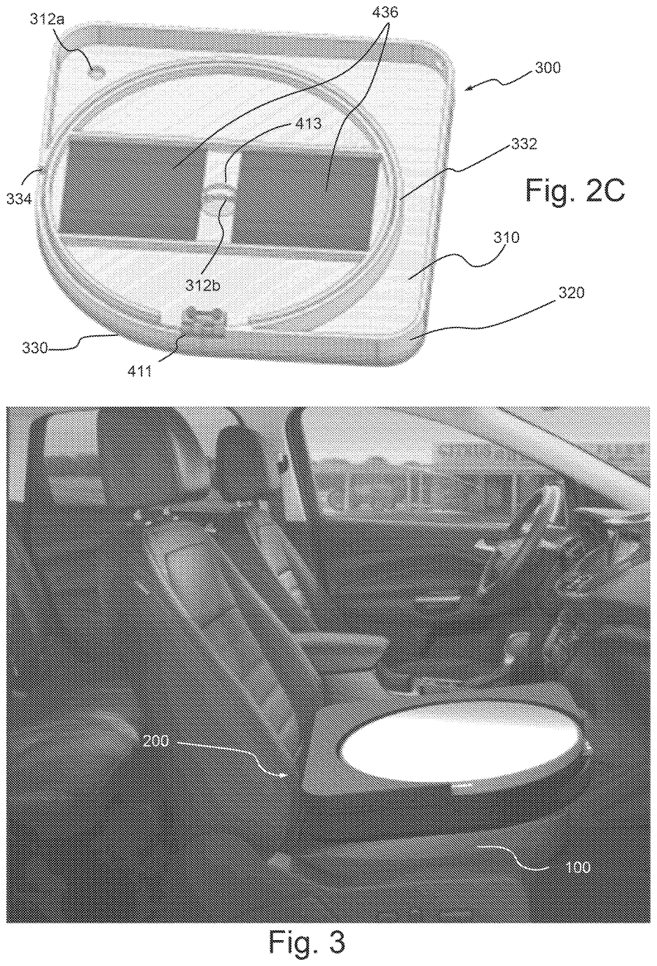

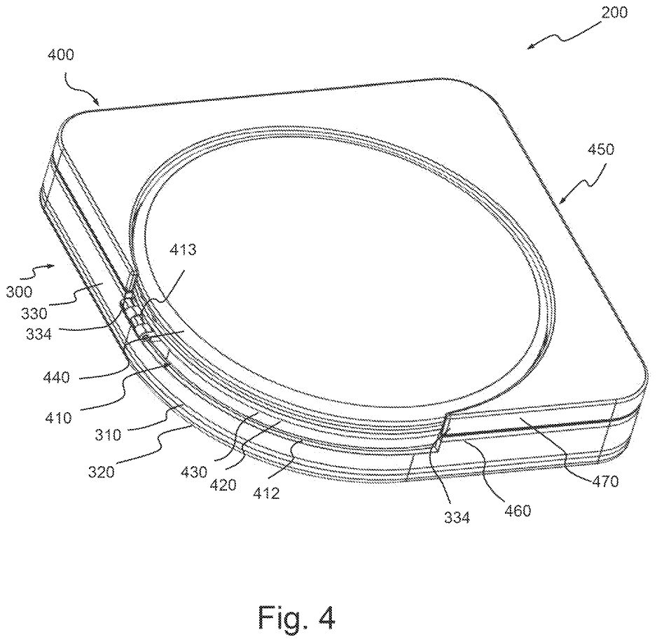

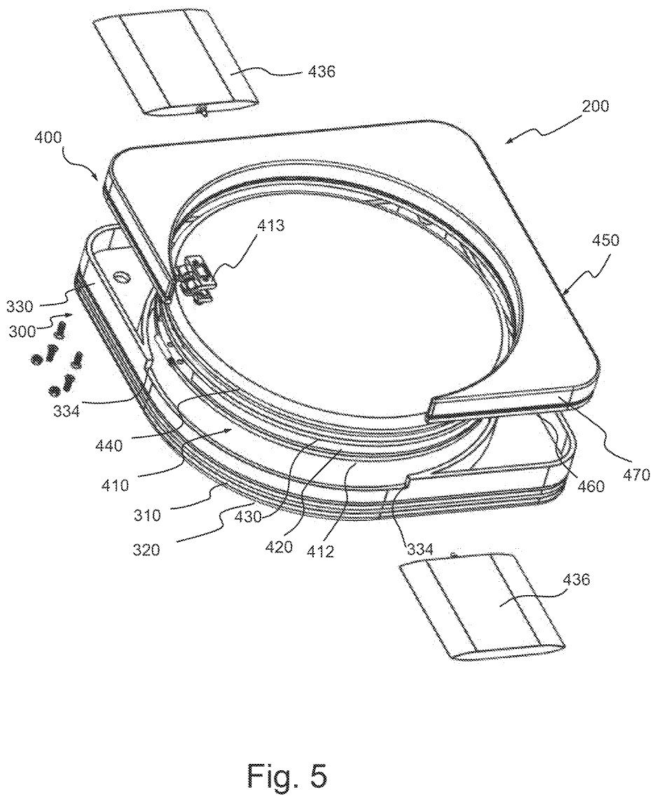

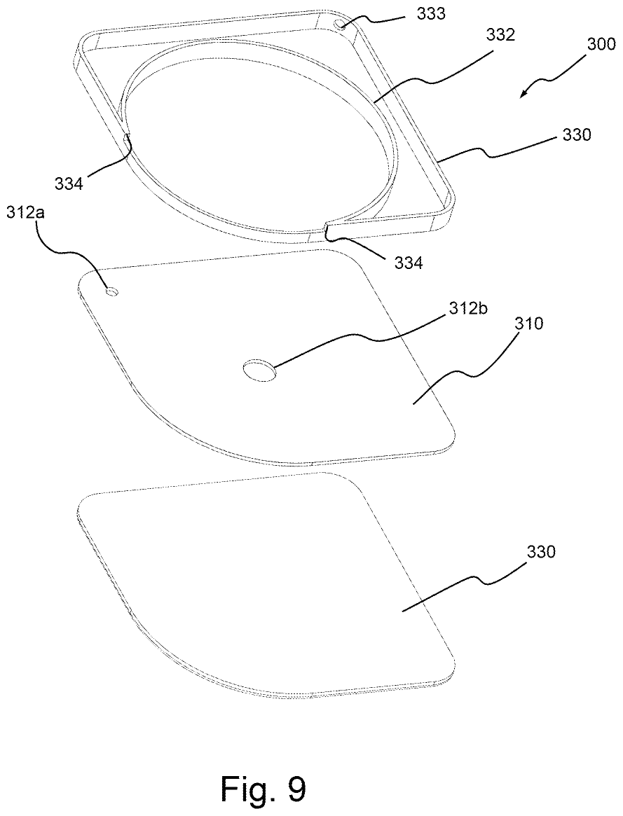

FIGS. 2A through 9 illustrates another representative embodiment of a vehicle seat device 200 hereof. Similar to device 10, device 200 includes a base 300 and a seating section or seat 400. In the illustrated embodiment, base 300 includes a relatively rigid base plate 310. A seat interface 320 is attached to the bottom or bottom surface of base plate 310. In a number of embodiments, seat interface 320 is sufficiently deformable to conform generally to an upper surface of vehicle seat 100. Seat interface 320 may, for example, be formed from a flexible and/or resilient material such as a polymeric foam. In a number of embodiments, seat interface 320 is formed from a flexible outer material which forms an internal cavity in which a plurality of resilient or rigid elements (not shown; for example, resilient polymeric beads) are retained. In such an embodiment, seat interface 320 functions similarly to a bean bag.

Base 300 further includes a relatively rigid frame 330 in the illustrated embodiment, which is attached to and extends upward from an upper surface of base plate 310. An upper surface of frame 330 provides a surface upon which seat 400 rests. Moreover, an arced section 332 (see, for example, FIG. 2C; which may follow a generally circular path over a length thereof) within frame 330 and above or upon base plate 310 forms a recess or seating in which a dynamic or rotatable section 410 of seat 400 rotates. At least a portion of arced section 332 may be formed integrally with frame 330 and/or with base plate 310.

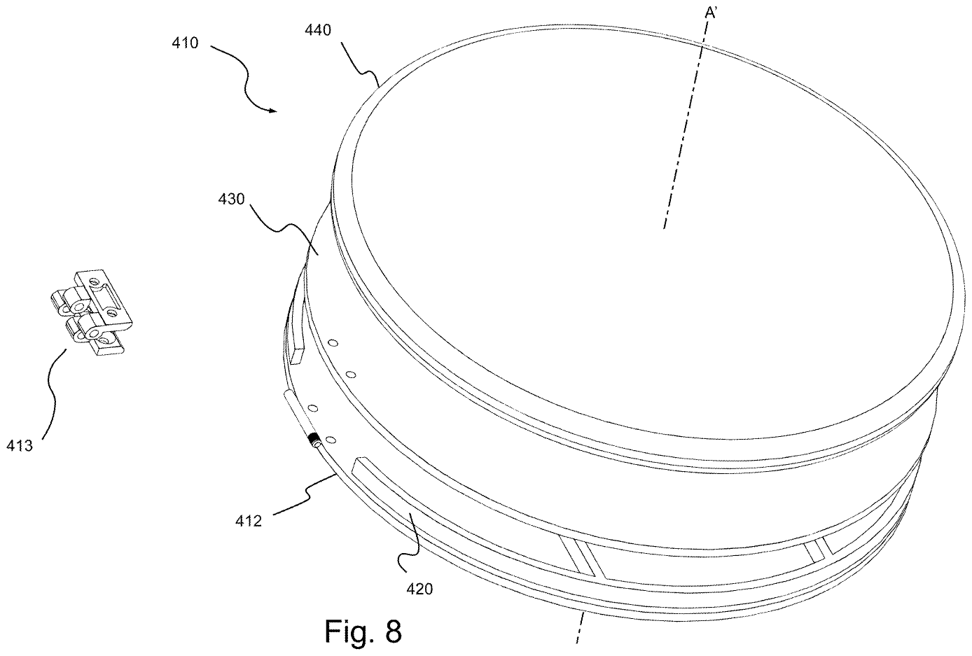

Seat 400 includes dynamic section 410, which rotates about an axis A′ thereof (see, for example, FIG. 8), relative to base 300. Seat 400 also includes a static section 450 in the illustrated embodiment which is stationary relative to base 300. In the illustrated embodiment, static section 450 of seat 400 rests upon and is connected to the upper surface of frame 330 of base 300, while (as described above) dynamic section 410 is rotatably seated within arced section 332 of frame 330.

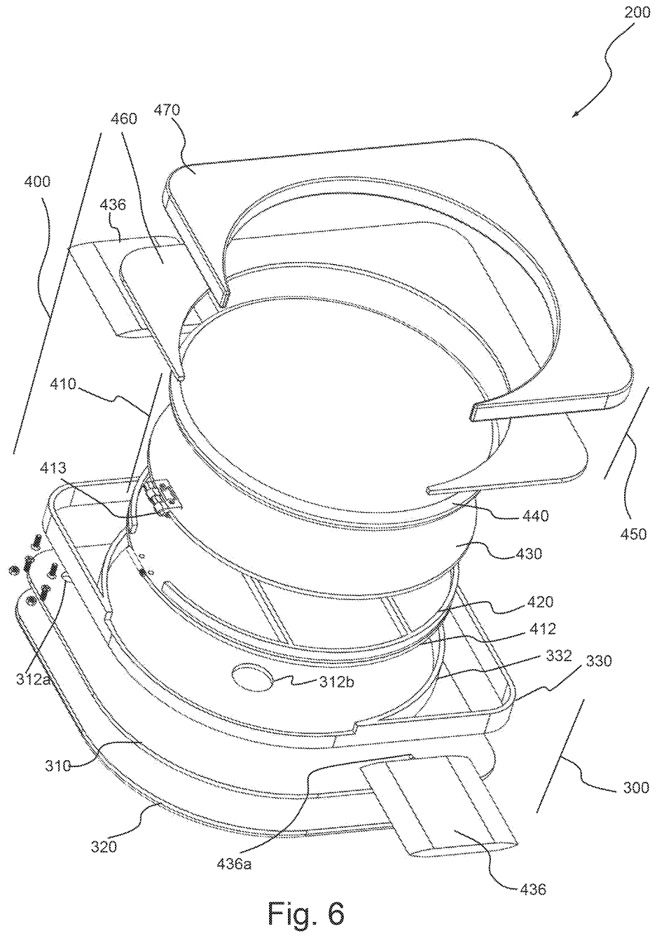

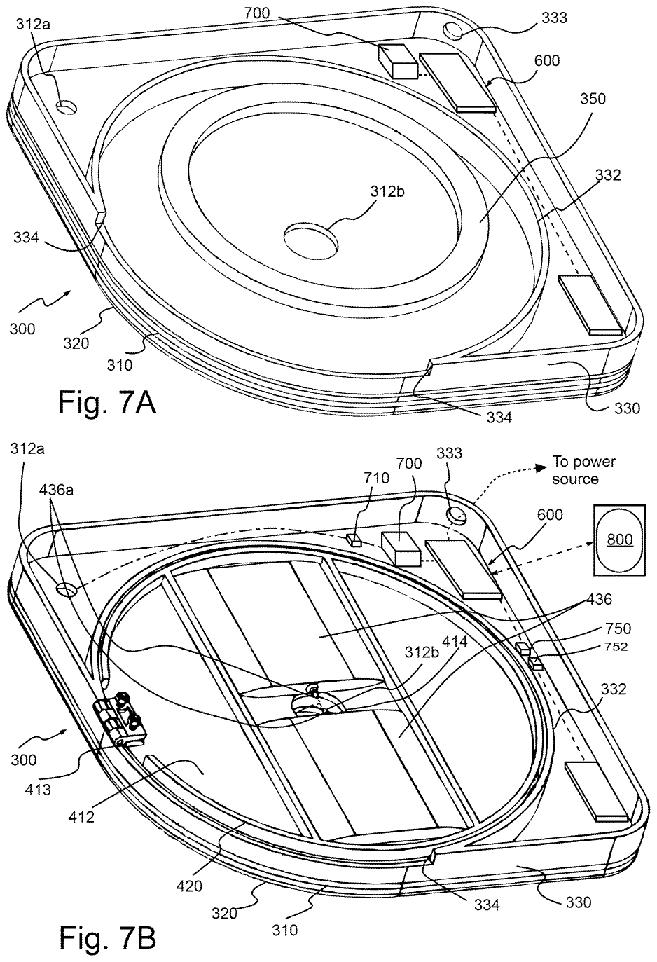

As, for example, illustrated in FIG. 6, static section 450 includes a lower, relatively rigid plate 460 which contacts the upper surface of frame 330 of base 300. A cushion 470 is attached to an upper surface of lower plate 460. In the illustrated embodiment, dynamic section 410 of seat 400, which is generally circular in shape, includes a lower or base section including a lower, relatively rigid plate 412, and an intermediate, relatively rigid frame section 420. Dynamic section 410 further includes an upper, relatively rigid plate 430. Intermediate frame section 420 is attached to and extends upward from lower plate 412. Upper, relatively rigid plate 430 rests upon an upper surface of frame section 420. A cushion 440 is attached to the upper surface of upper plate 430. As, for example, illustrated in FIGS. 2A, 3 and 4, the upper surface of cushion 470 of static seat section 450 and the upper surface of cushion 440 of dynamic seat section 410 may be generally flush to provide a consistent seating surface for the user and prevent pinching, compression, and other forms of discomfort during use. As illustrated in FIG. 7A, a generally circular ball bearing track may be positioned within arced section 332 of frame 330 to contact and cooperate with a lower surface of rigid plate 412 to provide ready rotation of dynamic section 410 relative to static section 450 (as well as relative to the remainder of device 200).

In the illustrated embodiment, lower plate 412 and upper plate 430 are connected via a hinge 413 such that upper plate 430 and connected cushion 440 are pivotable or tiltable relative to lower plate 412 and thus relative to the orientation plane of base 300 as illustrated in FIG. 2B to facilitate and improve safety in vehicle entry and/or exit as described above. In the volume or space created between lower plate 412 and upper plate 430 created by intermediate, upward extending frame section 420, one or more actuators 436 may be positioned to achieve a controlled tilt of upper plate 430 and connected cushion 440. In the illustrated embodiment, actuators 436 are or include inflatable bladders which may be controllably inflated/deflated under control of electronic circuitry 600 (see FIGS. 7A and 7B). However, other actuators such as, for example, electromechanical actuators, hydraulic actuators, or combinations thereof may be used.

As, for example, illustrated in FIGS. 7A and 7B, electronic circuitry 600 as discussed above, which may be at least partially housed in one or more housing modules, may be provided to achieve control of actuators 436. Electronic circuitry 600 may, for example, be in operative connection with one or more pneumatic pumps 700 (illustrated schematically in FIGS. 7A and 7B) which is/are in fluid connection with pneumatic connectors 436a of actuators 436. In the illustrated embodiment, pneumatic lines may pass through passages 312a and 312b formed in base plate 310 and a passage 414 formed in lower plate 412 (which aligns with passage 312b) to connect to pump(s) 700 with connectors 436a. Electronic circuitry 600 may, for example, be in operative or electrical (wired or wireless) connection with a control device or system 800 to control actuation of actuators 436. One or more pressure sensors 710 (illustrated schematically in FIGS. 7A and 7B) may be provided to assist in controlling inflation of inflatable bladders/actuators 436 and to prevent overinflation thereof. Control device or system 800 can, for example, include a fob or a similar switch device, which may be positioned in the vicinity of the vehicle door, to simply activate and deactivate actuators 436. In other embodiments, additional control can be provide by control device or system 800 which may, for example, include a personal communication device such as a smartphone. A control device component (such as a smartphone) may, for example, be used to communicate with electronic circuitry 600 to, for example, activate or deactivate actuators 436 as well as to change various parameters such as tilt angle and tilt rate of upper plate 430 via, for example, a control app saved on a smartphone or other personal communication device. As known in the art, electronic circuitry 600 may, in a number of embodiments, include a control system include a processor system and a memory system in communicative connection with the processor system. As also known in the art, the memory system may include one or more software-based algorithms executable by the processor system to control operation of, for example, actuators 436. Electronic circuitry 600 may further include a user interface, a communication system, an input/output system and a power system as know, for example, in the computer arts. The power system may, for example, include rechargeable batteries and/or a wired connection to a power source (for example, a 12V adapter port) within the vehicle via a passage 333 formed in frame 330. A release system (for example, a magnetic release system) can be provide for any cord or wire extending from device 10 to minimize tripping risks.

As described above dynamic turning or rotating motion of dynamic section 410 of seat 400 may be limited to approximately 90°. Such a limit in rotation is accomplished in the illustrated embodiment through the abutment of exposed hinge 413 against the edges 334 of a cut-out or open portion of frame 332 of base 300 which created an abutment surface. Ball bearing track 350 results in very little resistance to the rotation of dynamic section 410 relative to the remainder of device 10. Such ease of movement/rotation, however, may result in a rather abrupt stopping when hinge 413 makes contact with edges 334. Cushioned end elements (not shown), which may, for example, be formed of a resilient material, may be used in connection with edges 334 to assist in absorbing energy upon contact by hinge 413. Moreover, device 10 may include additional coverage or shielding over the pathway of travel of hinge 413 to reduce, minimize or eliminate risks of pinching or discomfort to the back of the leg of the user, which may come into contact with hinge 413.

A lock or locking mechanism 750 (illustrated schematically in FIG. 7B) may be provided to maintain upper plate 430 in a non-tilted or resting (seated/riding) position and/or to maintain upper plate 430 in a tilted (exiting) position. Locking mechanism may, for example, be in the form of an electronic, electromechanical, or mechanical locking mechanism. Locking mechanism 750 may, for example, prevent tilting unless dynamic seat section 410 (not illustrated in FIG. 7B; see, for example, FIGS. 6 and 8) is rotated to within a range of angles associated with exiting/entering the vehicle. The position of dynamic section 410 relative to static section 450 may be tracked via a rotary counter, switches, etc. as known in the position tracking arts. A lock or locking mechanism 752 (illustrated schematically in FIG. 7B) may also be provided to maintain a rotational position of dynamic seat section 410. Locking mechanisms 750 and 752 may be combined into a single mechanism or system in some embodiments.

Rigid elements or components such as base plate 410 and frame 310 of base 300 and lower plate 412, frame section 420, and upper plate 430 of dynamic seat section 410, as well as lower pate 460 of static seat section 450 were formed from wood in a number of studied embodiments. The rigid element or components of device 10 can, for example, be made of wood, polymeric materials, metals, or combinations thereof. The height of device 10 (that is, the distance device 10 extends above the surface of vehicle seat 100) in embodiments wherein device 10 is designed as a vehicle seat overlay may be minimized for enhanced safety and for ease of use in connection with taller users. In embodiments in which a vehicle seat device hereof is incorporated into or integrated with a vehicle seat, the top of the dynamic section of the vehicle seat device may be approximately flush with (or approximately even with or aligned with) an upper surface of the remainder of the vehicle seat.

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

1. A vehicle seat device, comprising:
a base, and
a seat connected to the base, the seat comprising a dynamic section that is rotatable relative to the base, at least a portion of the dynamic section being tiltable relative to the base from an untilted to a tilted position.

2. The vehicle seat device of claim 1 wherein the vehicle seat device is incorporated into a seat of a vehicle.

3. The vehicle seat device of claim 1 wherein the base is configured to be positioned on top of a surface of a seat of a vehicle.

4. The vehicle seat device of claim 3 wherein the seat comprises a static section and the dynamic section, wherein the static section is not movable relative to the base.

5. The vehicle seat device of claim 3 wherein the base comprises a base plate, a frame extending upward from the base plate, and an arced section in which at least a portion of the dynamic section of the seat is rotatably positioned.

6. The vehicle seat device of claim 1 wherein the dynamic section comprises a base section and an upper plate connected to the base section, the upper plate being tiltable relative to the base section.

7. The vehicle seat device of claim 6 further comprising at least one tilt actuator positioned between the base section and the upper plate of the dynamic section.

8. The vehicle seat device of claim 7 wherein the at least one tilt actuator comprises an inflatable bladder.

9. The vehicle seat device of claim 6 wherein the device further comprises a ball bearing track positioned between the base of the vehicle seat device and the base section of the dynamic section.

10. The vehicle seat device of claim 6 wherein the upper plate is tiltably connected to the base section of the dynamic section via a hinge.

11. The vehicle seat device of claim 10 wherein rotation of the dynamic section relative to the base is limited.

12. The vehicle seat device of claim 11 wherein rotation of the dynamic section relative to the base is limited to approximately 90 degrees or less.

13. The vehicle seat device of claim 1 wherein the base further comprises an interface attached to a lower surface of the base, the interface being configured to conform to a conformation of the vehicle seat.

14. The vehicle seat device of claim 1 wherein the at least a portion of the dynamic section is configured to provide a forward tilt in the tilted position to assist in at least one of exiting or entering the vehicle.

15. A method of providing assistance in transfer of a user in entering and exiting a vehicle, the method, comprising:
positioning a vehicle seat device in operative connection with a seat of the vehicle, the vehicle seat device comprising a base and a seat connected to the base, the seat comprising a dynamic section that is rotatable relative to the base, at least a portion of the dynamic section being tiltable relative to the base, the dynamic section being rotatable relative to the base upon force applied by the user when seated on the vehicle seat device, and
tilting the at least a portion of the dynamic section from an untilted position to a tilted position to provide a forward tilt to the user to assist in at least one of exiting or entering the vehicle.

16. The method of claim 15 wherein the vehicle seat device is incorporated into the seat of the vehicle.

17. The method of claim 15 wherein the base is configured to be positioned on top of a surface of the seat of the vehicle.

18. The method of claim 17 wherein the seat comprises a static section and the dynamic section, wherein the static section is not movable relative to the base.

19. The method of claim 17 wherein the base comprises a base plate, a frame extending upward from the base plate, and an arced section in which at least a portion of the dynamic section of the seat is rotatably positioned.

20.-28. (canceled)

29. A vehicle seat system comprising: a vehicle seat, and a vehicle seat device in operative connection with the vehicle seat, the vehicle seat device comprising a base and a seat connected to the base, the seat including a dynamic section that is rotatable relative to the base, at least a portion of the dynamic section being tiltable from an untilted position to a tilted position relative to the base.
